(19) United States
(12) Patent Application Publication
(10) Pub. No.: US 2010/0077238 A1
(43) Pub. Date: Mar. 25, 2010

(54) ENERGY EFFICIENCT POWER SUPPLY SYSTEM

(75) Inventors: Viktor D. Vogman, Olympia, WA (US); Brian Griffith, Auburn, WA (US); Gopal Mundada, Olympia, WA (US)

Correspondence Address: INTEL/BSTZ;BLAKELY SOKOLOFF TAYLOR & ZAFMAN LLP, 1279 OAKMEAD PARKWAY, SUNNYVALE, CA, 94085-4040, US

(73) Assignee: WISCONSIN ALUMNI RESEARCH FOUNDATION, Madison, WI (US)

(21) Appl. No.: 12/238,297

(22) Filed: Sep. 25, 2008

(51) Int. Cl. G06F 1/26

(52) U.S. Cl. 713/310; 713/300; 713/340

(57) ABSTRACT

An energy efficient power supply system is disclosed. The energy efficient power supply system comprises a plurality of power supply units and the power supply system may be coupled to the control logic. The control logic may be coupled to the power monitor unit. The power monitor unit may determine a power consumption value, which may represent power requirement of a power consuming system such as a computer system. The control logic may determine the power supply units of the plurality of power supply units that are to be activated to provide power to match the power requirement. The control logic may identify the power supply units that may be activated to operate at a maximum efficiency value while providing power specified by the power consumption value.

### BACKGROUND

Power supply systems may be used to provide power to personal computers, servers, network devices, and similar other systems to enable the systems to perform its function. At least some of such systems may require un-interrupted supply of power to provide reliable un-interrupted service. To provide un-interrupted supply of power to such systems, redundant power systems are provisioned to provide power in the event of failure of active power supply. Such an arrangement may need energy efficient power systems.

### BRIEF DESCRIPTION OF THE DRAWINGS

The invention described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements.

FIG. 1 illustrates an arrangement 100 comprising an energy efficient power supply system 105 in accordance with one embodiment.

FIG. 2 illustrates a control logic 150, which implements energy efficient techniques to enhance the efficiency of the power supply system 105 in accordance with one embodiment.

FIG. 3 illustrates a technique based on which the control logic 150 enhances the efficiency of the power supply system 105 in accordance with one embodiment.

FIG. 4 depicts a graph 400 illustrating the enhancement in the energy efficiency of the power supply system 105 in accordance with one embodiment.

### DETAILED DESCRIPTION

The following description describes an energy efficient power supply system. In the following description, numerous specific details such as logic implementations, resource partitioning, or sharing, or duplication implementations, types and interrelationships of system components, and logic partitioning or integration choices are set forth in order to provide a more thorough understanding of the present invention. It will be appreciated, however, by one skilled in the art that the invention may be practiced without such specific details. In other instances, control structures, gate level circuits, and full software instruction sequences have not been shown in detail in order not to obscure the invention. Those of ordinary skill in the art, with the included descriptions, will be able to implement appropriate functionality without undue experimentation.

References in the specification to “one embodiment”, “an embodiment”, “an example embodiment”, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Embodiments of the invention may be implemented in hardware, firmware, software, or any combination thereof. Embodiments of the invention may also be implemented as instructions stored on a machine-readable medium, which may be read and executed by one or more processors. A machine-readable medium may include any mechanism for storing or transmitting information in a form readable by a machine (e.g., a computing device).

For example, a machine-readable medium may include read only memory (ROM); random access memory (RAM); magnetic disk storage media; optical storage media; flash memory devices; electrical, optical, acoustical or other forms of signals. Further, firmware, software, routines, and instructions may be described herein as performing certain actions. However, it should be appreciated that such descriptions are merely for convenience and that such actions in fact result from computing devices, processors, controllers, and other devices executing the firmware, software, routines, and instructions.

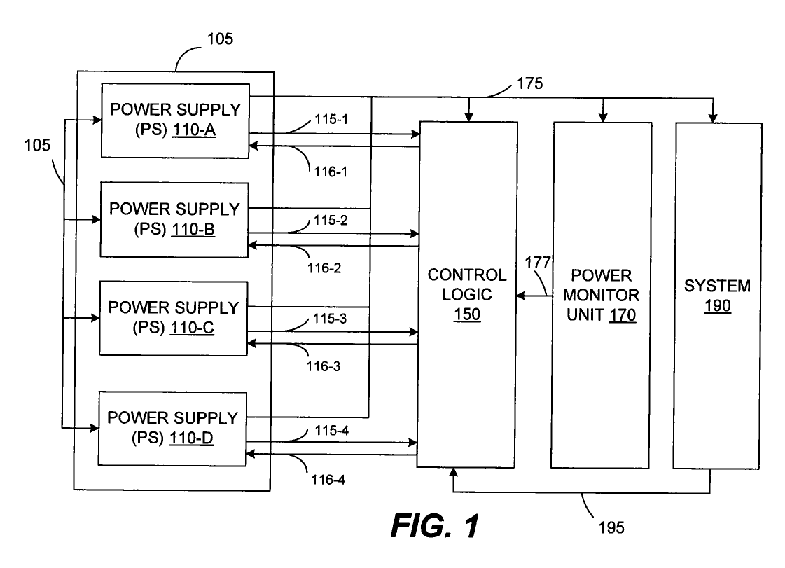

An embodiment of an arrangement 100, which uses an energy efficiency power supply system 105 is illustrated in FIG. 1. In one embodiment, the arrangement 100 may comprise a power supply system 105, control logic 150, power monitor unit 170, and a power consuming system 190. In one embodiment, the power consuming system 190 may comprise one or more computer systems such as a server farm, networked computers, data center devices and other similar devices.

In one embodiment, the power supply system 105 may comprise a plurality of power supply units 110. In one embodiment, the power supply unit 105 may comprise four power supply units 110-A to 110-D. However, the power supply unit may comprise less than or more than four power supply units 110. In one embodiment, the power supply units 110-A to 110-D may be coupled to each other by a current sense bus 105 to maintain the power balance. In one embodiment, while a power supply unit 110 is coupled to the AC mains, a low power standby output may be provided to the computer system 190 on the path 175. In one embodiment, the lower power standby output may enable a user of the computer system 190 to switch ON or activate the computer system 190.

In one embodiment, one or more power supply units 110 may be switched ON or activated to provide power to the computer system 190 based on a control signal received from the control logic 150. In one embodiment, a power supply unit 110-A may be switched ON or activated in response to receiving an ‘enable signal’ on path 116-1 from the control logic 150. In other embodiment, the power supply units 110-A, 110-B, and 110-C may be switched ON if power supply units 110-B, 110-C, and 110-D receive an enable signal on paths 116-2, 116-3, and 116-4, respectively.

In one embodiment, if the power supply unit 110-A is switched ON, other power supply units 110-B to 110-D may be referred to as redundant power supply units. In other embodiment, if the power supply units 110-A to 110-C is switched ON then the power supply unit 110-D may be referred to as a redundant power supply unit. In one embodiment, the power supply units 110 may be capable of generating a ‘fault signal’ based on occurrence of events such as component failure, over-voltage, under-voltage, over-temperature, over-current, fan failure and such other similar events. In one embodiment, the power supply units 110-A, 110-B, 110-C, and 110-D may provide the fault signal to the control logic 150 on paths 115-1, 115-2, 115-3, and 115-4, respectively. In one embodiment, a power OK or power good signal (PWOK) de-assertion event may be used as a fault signal.

In one embodiment, the power supply units 110 may be characterized by power and efficiency ratings. In one embodiment, the power supply units 110 may be characterized by power source and efficiency ratings.

In one embodiment, the computer system 190 may be coupled to the power supply system 105 using a power supply bus 175. In one embodiment, the computer system 190 may receive a low power standby output from a power supply unit, for example, 110-A coupled to the AC mains. In one embodiment, the computer system 190 may generate a power_supply_ON (PS_ON) signal on a path 195, in response to a user pressing the power ON button provided on the front panel of the computer system 190. In one embodiment, the PS_ON signal on path 195 may be used to switch ON one or more power supply units 110.

In one embodiment, the computer system 190 may operate at workloads, which may be different at different time points. In one embodiment, the power drawn by the computer system 190 may also vary with the changing workload. In one embodiment, a power monitoring unit 170 coupled to the power supply bus 175 may monitor the power drawn from the power supply system 105. In one embodiment, the power monitoring unit 170 may provide power consumption values to the control logic 150 on path 177.

In one embodiment, to start the operation, the control logic 150 may switch ON one or more power supply units 110 in response to receiving the PS_ON signal from the computer system 190. In one embodiment, if a power supply unit 110-A is capable of supplying the power consumed by the computer system 190 at a desired efficiency level, the control logic 150 may generate a control signal that switches ON the power supply unit 110-A. In other embodiment, the control logic 150 may generate a control signal, which may switch ON the power supply units 110-A and 110-B to meet the power consumption of the computer system 190 and/or to reach a desired efficiency level. In one embodiment, the control logic 150 may be supplied power from the power supply system 105.

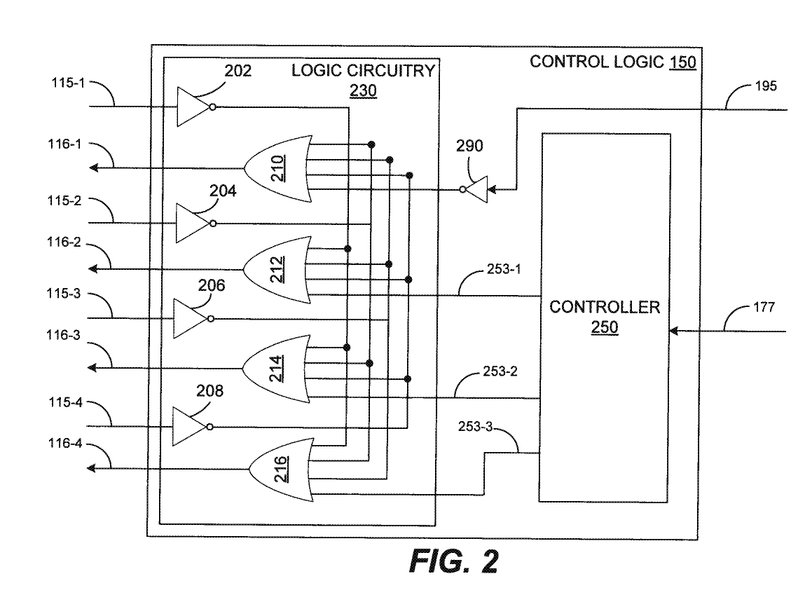

An embodiment of the control logic 150, which implements energy efficient techniques to enhance the efficiency of the power supply system 105 is illustrated in FIG. 2. In one embodiment, the control logic 150 may comprise a logic circuitry 230 and a controller 250.

In one embodiment, the logic circuitry 230 may comprise NOT logic gates 202, 204, 206 and 208 and OR logic gates 210, 212, 214, and 216. In one embodiment, the OR logic gates 210, 212, 214, and 216 may be four input OR gates that generate an output based on the four input values. In one embodiment, the OR gate 210 may receive outputs of NOT logic gates 204, 206, and 208 as a first, second, and a third input and an inverted version of the PS_ON signal from the computer system 190 as a fourth input.

In one embodiment, the OR logic gate 212 may receive outputs of NOT logic gates 202, 206, and 208 as a first, second, and a third input and a control signal from the controller 250 as a fourth input. In one embodiment, if at least one input is at logic high value, the output of the OR logic gate 212 is at logic high, which in turn may enable one or more power supply units 110. In one embodiment, the OR logic gate 214 may receive outputs of NOT logic gates 202, 204, and 208 as a first, second, and a third input and an output signal from the controller 250 as a fourth input. In one embodiment, the OR logic gate 216 may receive outputs of NOT logic gates 202, 204, and 206 as a first, second, and a third input and an output signal from the controller 250 as a fourth input.

In one embodiment, the NOT logic gates 202, 204, 206, and 208 may receive fault signals generated by the power supply units 110-A to 110-D as the inputs, respectively. In one embodiment, if the power supply unit 110-A generates a fault signal, a logic low value may be provided at the input of NOT logic gate 202. In one embodiment, the output of the NOT logic gate 202, which is a logic high value, may be provided as an input to the OR logic gates 212, 214, and 216. Thus, the output of the OR logic gates 212, 214, and 216, which may be provided as enable signals to the power supply units 110-B, 110-C, and 110-D may switch ON the power supply units 110-B, 110-C, and 110-D. In other embodiment, the output of the NOT logic gate 202 may be used by the controller 250 to selectively switch ON power supply unit 110-B or 110-C, or 110-D or combinations thereof.

Like-wise, if the power supply units 110-A and 110-B generate a fault signal, the logic circuitry 230 may switch ON power supply units 110-C and 110-D. In other embodiment, the output of NOT logic gates 202 and 204 may be used to switch ON the power supply unit 110-C, or 110-D, or both 110-C and 110-D.

In one embodiment, the controller 250 may generate a control signal based on the power consumption values received from the power monitor unit 170 on path 177. In one embodiment, the controller 250 may provide the control signals to the logic circuitry 230. In one embodiment, the controller 250 may comprise an electronic circuitry such as a microcontroller.

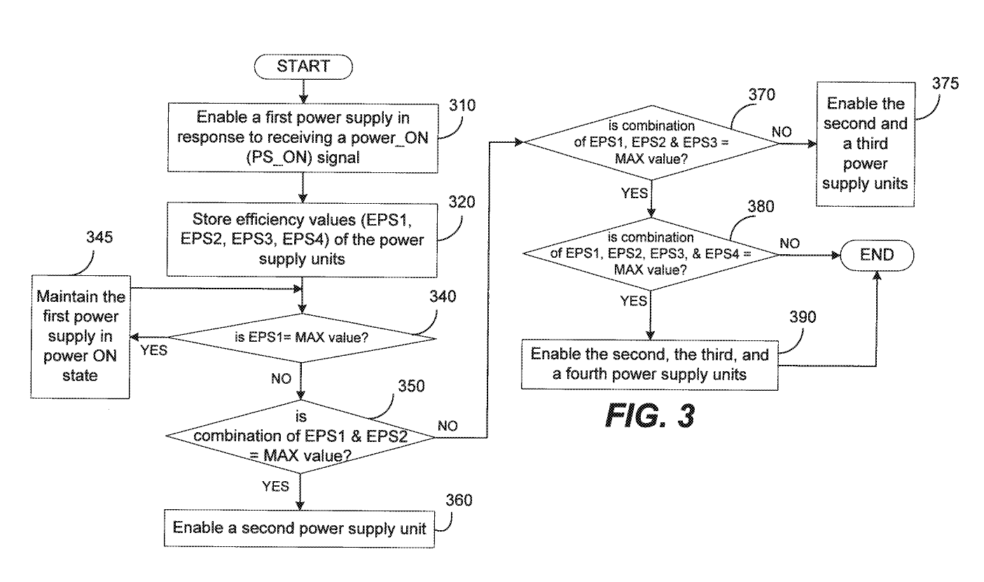

An embodiment of a technique based on which the control logic 150 enhances the efficiency of the power supply system 105 in accordance with one embodiment is illustrated in FIG. 3.

In block 310, the control logic 150 may enable a first power supply in response to receiving a power_supply_ON (PS_ON) signal from the computer system 190. In one embodiment, the control logic 150 may receive the PS_ON signal and may provide the PS_ON signal as an input to the OR logic gate 210. In one embodiment, the PS_ON signal may be logic low signal and the PS_ON signal may be inverted using the NOT logic gate 290 before providing the inverted PS_ON signal as an input to the OR logic gate 210. In one embodiment, the output of the OR logic gate 210 may be provided as an enable signal to the power supply unit 110-A. In one embodiment, the power supply unit 110-A may be switched ON in response to receiving the enable signal. It may be noted that any other power supply unit 110 may also be switched ON using the PS_ON signal.

In block 320, the control logic 150 may store efficiency values EPS1, EPS2, EPS3, and EPS4 of the power supply units 110-A, 110-B, 110-C, and 110-D, respectively. In one embodiment, the control logic 150 may store efficiency values in a memory area provided within the controller 250. In one embodiment, for example, the efficiency values may be provided as: Example 1: at P=200 W level, one power supply unit's efficiency (EPS1) is 90%, two power supply unit's efficiency (combination of EPS1 and EPS2) is 80%, and three power supply unit's efficiency (combination of EPS1, EPS2, and EPS3) may be 70%. In Example 2: at P=2000 W, two power supply unit's efficiency is 87%, three power supply unit's efficiency is 89%, and four power supply unit's efficiency is 88%.

In block 340, the control logic 150 may check if the EPS1 is equal to a maximum efficiency value (MAX value) and may cause control to pass to block 345 if EPS1 is equal to Max value and to block 350 otherwise. In one embodiment, the maximum efficiency value (MAX value) may refer to a highest power system efficiency value for a given power level and for a number of active power supply units. In one embodiment, the MAX value may be determined based on the power supply unit's efficiency curve or a look-up table provided by the vendors. In one embodiment, the MAX value may also be determined using the Equation (1) provided below:

$${Eff}_{CR} ( {\hat{P}}_{o} ) = \frac{{n}_{A}}{\frac{{n}_{A}}{{Eff}_{1} ( {\hat{P}}_{o} / {n}_{A} )} + \frac{{\hat{P}}_{SB} \cdot ( N - {n}_{A} )}{{\hat{P}}_{o} \cdot {Eff}_{1} ( {\hat{P}}_{max} )}} \qquad Equation ( 1 )$$

wherein Eff₁(\hat{P}ₒ/n_{A})-single power supply unit efficiency at (\hat{P}ₒ/n_{A}) level; \hat{P}_{SB}—input standby power normalized to the power supply unit input maximum power; n_{A}—total number of active power supply units 110 in the power supply system 105; N—total number of power supply units 110 in the power supply system 105; Eff₁(\hat{P}ₒmax)—single power supply unit's efficiency at maximum load; \hat{P}ₒ=P₀/P₀₁ₘₐₓ; and P₀—output power consumption values provided by the power monitor unit 170.

In one embodiment, the control logic 150 may determine the power supply units 110 that may be switched ON using the MAX value and the power consumption values provided by the power monitor unit 170. In one embodiment, if the power consumption value provided by the power monitor unit equals 200 watts and if the MAX value equals 90%, the control logic 150 may compare the EPS1 with the MAX value and may cause control to pass to block 345 if EPS1 is equal to MAX value and to block 350 otherwise. In one embodiment, in Example1 above, the highest efficiency value of 90% may be provided by a single power supply unit 110-A. Thus, the control logic 150 may continue to maintain the power supply unit 110-A in ON state. In other embodiment, in Example2 above, the MAX value is 89%, which may be a combination of three power supply units 110-A, 110-B, and 110-C, for example.

In block 345, the control logic 150 may continue to maintain the first power supply unit in a power ON state as EPS1 equals the MAX value. In block 350, the control logic 150 may check if the combination of efficiency values of power supply unit 110-A and 110-B equals the MAX value and control passes to block 360 if the combination of EPS1 and EPS2 equals the MAX value and to block 370 otherwise.

In block 360, the control logic 150 may cause the second power supply unit, 110-B, for example, to be switched ON by providing a logic high value on the path 253-1. In one embodiment, the combination of the power supply units 110-A and 110-B may provide power that may be consumed by the computer system 190.

In block 370, the control logic 150 may check if the combination of efficiency values of power supply unit 110-A, 110-B, and 110-C equals the MAX value and control passes to block 375 if the combination of efficiency values of the power supply unit 110-A, 110-B, and 110-C equals MAX value and control passes to block 380 otherwise.

In block 375, the control logic 150 may cause the second and the third power supply units, 110-B and 110-C, for example, to be switched ON by, respectively, providing a logic high value on the paths 253-1 and 253-2. In one embodiment, the combination of the power supply units 110-A, 110-B, and 110-C may provide power that may be consumed by the computer system 190.

In block 380, the control logic 150 may check if the combination of efficiency values of power supply unit 110-A, 110-B, 110-C, and 110-D equals the MAX value. Control passes to block 390 if the combination of efficiency values of the power supply unit 110-A, 110-B, 110-C and 110-D equals MAX value.

In block 390, the control logic 150 may cause the second, the third, and the fourth power supply units, 110-B, 110-C, and 110-D, for example, to be switched ON by providing a logic high value on the paths 253-1, 253-2, and 253-3, respectively. In one embodiment, the combination of the power supply units 110-A, 110-B, 110-C and 110-D may provide power that may be consumed by the computer system 190.

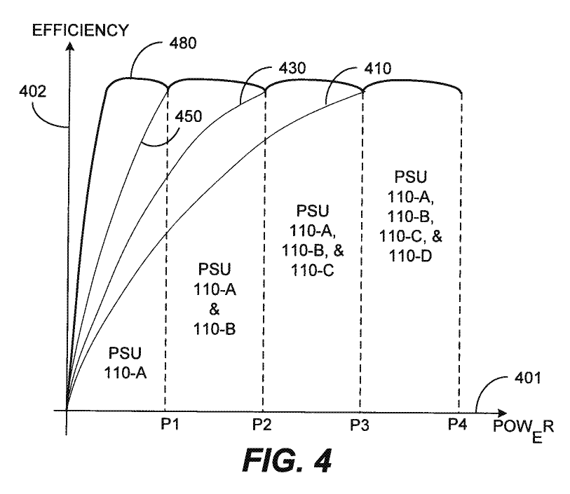

A graph 400 depicting the enhancement in the energy efficiency of the power supply system 105 in accordance with one embodiment is illustrated in FIG. 4. In one embodiment, the graph 400 comprises X-axis 401 and a Y-axis 402. In one embodiment, the X-axis 401 may represent the power consumed and a Y-axis 402 may represent the efficiency.

In one embodiment, the resultant efficiency of the power system 105 may be represented by a curve 480, while the power supply system 105 uses the energy efficiency techniques described above. A curve 410 may represent efficiency of a power supply system while the power supply units 110-A to 110-D are enabled using a 2+2 topology. The curve 410 as compared to the curve 480 (in the range P2-P3) depicts that the efficiency is substantially lower in the power range 0-P3, than the efficiency provided by the power supply system 105 while three power supply units 110-A to 110-C, for example, are switched ON using the energy enhancing techniques described above.

The curve 410 as compared to the curve 480 (in the range P1-P2) depicts that the efficiency is substantially lower in the power range 0-P2, than the efficiency provided by the power supply system 105 while two power supply units 110-A and 110-B, for example, are switched ON using the energy enhancing techniques described above. The curve 410 as compared to the curve 480 (in the range P0-P1) depicts that the efficiency is substantially lower in the power range 0-P1, than the efficiency provided by the power supply system 105 while one power supply unit 110-A, for example, is switched ON using the energy enhancing techniques described above.

A curve 430 may represent efficiency of a power supply system while the power supply units 110-A to 110-C are enabled using a 2+2 topology. The curve 430 as compared to the curve 480 (in the range P1-P2) depicts that the efficiency is substantially lower in the power range 0-P2, than the efficiency provided by the power supply system 105 while two power supply units 110-A and 110-B, for example, are switched ON using the energy enhancing techniques described above. The curve 430 as compared to the curve 480 (in the range 0-P1) depicts that the efficiency is substantially lower in the power range 0-P1, than the efficiency provided by the power supply system 105 while one power supply unit 110-A, for example, is switched ON using the energy enhancing techniques described above.

A curve 450 may represent efficiency of a power supply system while the power supply unit 110-A and 110-B are enabled using a 2+2 topology. The curve 450 as compared to the curve 480 (in the range P0-P1) depicts that the efficiency is substantially lower in the power range 0-P1, than the efficiency provided by the power supply system 105 while one power supply unit 110-A, for example, is switched ON using the energy enhancing techniques described above.

Certain features of the invention have been described with reference to example embodiments. However, the description is not intended to be construed in a limiting sense. Various modifications of the example embodiments, as well as other embodiments of the invention, which are apparent to persons skilled in the art to which the invention pertains are deemed to lie within the spirit and scope of the invention.

What is claimed is:

1. A method comprising:
determining a power consumption value, wherein the power consumption value represents power requirement of a power consuming system,
determining power supply units that are to be activated to provide power to match the power requirement, wherein the power supply units that are identified to be activated is to operate at a maximum efficiency value while providing power specified by the power consumption value, and
activating the power supply units, which are identified to be activated.

2. The method of claim 1, wherein the maximum efficiency value is determined using data derived from efficiency curves of power supply units.

3. The method of claim 1 further comprises providing enable signals to the power supply units, which are identified to be activated, wherein providing the enable signals to the power supply units activate the power supply units.

4. The method of claim 3, wherein the enable signals are generated based on comparing efficiency values of power supply units with the maximum efficiency value.

5. The method of claim 4, wherein the enable signals are provided to a second, third, and a fourth power supply unit if a first power supply unit is not able operate at the maximum efficiency level while providing the power specified by the power consumption value.

6. The method of claim 4, wherein the enable signals are provided to a second and a fourth power supply unit if a first power supply unit is unable to operate at the maximum efficiency level while providing the power specified by the power consumption value.

7. The method of claim 3, wherein an enable signal is provided to a second power supply unit of the power supply units if a first power supply unit generates a fault signal.

8. The method of claim 7, wherein the enable signals are provided to the second power supply unit, a third power supply unit, and a fourth power supply unit if the first power supply unit generates the fault signal.

9. The method of claim 7, wherein the enable signals are provided to the second power supply unit and the fourth power supply unit if the first power supply unit generates the fault signal.

10. An apparatus comprising:
a plurality of power supply units, a power monitor unit, wherein the power monitor unit is to determine a power consumption value, wherein the power consumption value represents power requirement of a power consuming system, and
a control logic coupled to the power monitor unit and the plurality of power supply units,
wherein the control logic is to determine power supply units of the plurality of power supply units that are to be activated to provide power to match the power requirement,
wherein the power supply units that are identified to be activated is to operate at a maximum efficiency value while providing power specified by the power consumption value, and
wherein the control logic is to activate the power supply units, which are identified to be activated.

11. The apparatus of claim 10 the control logic further comprises a controller, wherein the controller is to determine the maximum efficiency value using data derived from efficiency curves of power supply units.

12. The apparatus of claim 10, wherein the control logic further comprises a logic circuitry, wherein the logic circuitry is to provide enable signals to the power supply units, which are identified to be activated, wherein the enable signals activate the power supply units.

13. The apparatus of claim 12, wherein the controller is to generate control signals based on comparing efficiency values of power supply units with the maximum efficiency value, wherein the enable signals are generated based on the control signals.

14. The apparatus of claim 13, wherein the logic circuitry is to provide enable signals to a second, third, and a fourth power supply unit if a first power supply unit is not able operate at the maximum efficiency level while providing the power specified by the power consumption value.

15. The apparatus of claim 13, wherein the logic circuitry is to provide enable signals to a second and a fourth power supply unit if a first power supply unit is unable to operate at the maximum efficiency level while providing the power specified by the power consumption value.

16. The apparatus of claim 12, wherein the logic circuitry is to provide an enable signal to a second power supply unit of the power supply units if a first power supply unit generates a fault signal.

17. The apparatus of claim 16, wherein the logic circuitry is to provide the enable signals to the second power supply unit, a third power supply unit, and a fourth power supply unit if the first power supply unit generates the fault signal.

18. The apparatus of claim 16, wherein the logic circuitry is to provide the enable signals to the second power supply unit and the fourth power supply unit if the first power supply unit generates the fault signal.

19. A system comprising:
a power supply arrangement, wherein the power supply arrangement comprises a plurality of power supply units,
a power consuming device coupled to the power supply system,
a power monitor unit coupled to the power consuming device, wherein the power monitor unit is to determine a power consumption value, wherein the power consumption value represents power requirement of a power consuming device, and
a control logic coupled to the power monitor unit and the power supply arrangement,
wherein the control logic is to determine power supply units of the plurality of power supply units that are to be activated to provide power to match the power requirement,
wherein the power supply units that are identified to be activated is to operate at a maximum efficiency value while providing power specified by the power consumption value, and
wherein the control logic is to activate the power supply units, which are identified to be activated.

20. The system of claim 19, wherein the control logic is to determine the maximum efficiency value using data derived from efficiency curves of power supply units.

21. The system of claim 20, wherein the control logic is to provide enable signals to the power supply units, which are identified to be activated, wherein the enable signals activate the power supply units.

22. The system of claim 21, wherein the control logic is to generate control signals based on comparing efficiency values of power supply units with the maximum efficiency value, wherein the enable signals are generated based on the control signals.

23. The system of claim 22, wherein the control logic is to provide enable signals to a second, third, and a fourth power supply unit if a first power supply unit is not able to operate at the maximum efficiency level while providing the power specified by the power consumption value.

24. The system of claim 21, wherein the control logic is to provide an enable signal to a second power supply unit of the power supply units if a first power supply unit generates a fault signal.

25. The system of claim 24, wherein the logic circuitry is to provide the enable signals to the second power supply unit and the fourth power supply unit if the first power supply unit generates the fault signal.
